(19) United States
(12) Patent Application Publication
(10) Pub. No.: US 2015/0241077 A1
(43) Pub. Date: Aug. 27, 2015

(54) AIR CONDITIONING CONTROL SYSTEM AND AIR CONDITIONING CONTROL METHOD

(71) Applicant: FUJITSU LIMITED, Kawasaki-shi (JP)

(72) Inventors: Masatoshi OGAWA, Isehara (JP); Hiroshi ENDO, Isehara (JP); Hiroyuki FUKUDA, Ebina (JP); Masao KONDO, Sagamihara (JP)

(21) Appl. No.: 14/580,775

(22) Filed: Dec. 23, 2014

(30) Foreign Application Priority Data
Feb. 27, 2014 (JP) 2014-037024

(51) Int. Cl. F24F 11/00; G05B 13/02

(52) U.S. Cl. CPC F24F 11/006; G05B 13/026

(57) ABSTRACT

A disclosed air conditioning control system includes: a flow path through which cooling air discharged from an exhaust surface of an electronic apparatus is returned to an intake surface thereof, a damper provided in the flow path, a temperature measuring unit for measuring the real temperature of the cooling air, a humidity measuring unit for measuring the real humidity of the cooling air, a target value changing unit for changing target temperature and humidity in accordance with the real temperature and humidity, and a controlling unit for predicting future predicted values of the real temperature and humidity, and controlling the opening extent of the damper such that the predicted temperature and humidity become close to the target temperature and humidity, respectively. The target value changing unit sets the target temperature and humidity such that the real temperature and humidity are raised and lowered in the opposite directions.

### CROSS-REFERENCE TO RELATED APPLICATION

This application is based upon and claims the benefit of priority of the prior Japanese Patent Application No. 2014-37024, filed on Feb. 27, 2014, the entire contents of which are incorporated herein by reference.

### FIELD

The embodiment discussed herein is related to an air conditioning control system and an air conditioning control method.

### BACKGROUND

In datacenters, jobs are distributed to a plurality of electronic apparatuses such as servers, and each electronic apparatus executes its jobs. Each electronic apparatus is provided with a heat generating component such as a central processing unit (CPU). When processing a large amount of jobs, the CPU temperature rises, which may result in failure of the electronic apparatus or deterioration in the performance thereof.

To prevent such rise in CPU temperature, datacenters are provided with mechanisms to cool their electronic apparatuses. Among them, module-type datacenters configured to take in external air as cooling air are effective in terms of energy saving since they have no heat exchanger for cooling the external air.

In such a module-type datacenter, warm cooling air discharged from the exhaust surface of each electronic apparatus is sent back to the intake surface of each electronic apparatus. In this way, it is possible to prevent excessive cooling of the electronic apparatus during the winter season, for example. Moreover, by supplying the warm cooling air to the intake surface of the electronic apparatus in this manner, the humidity around the intake surface can be adjusted as well.

However, there is still room for improvement in module-type datacenters for further energy saving.

Note that a technology related to this application is disclosed in Japanese Laid-open Patent Publication No. 2013-92298.

### SUMMARY

According to one aspect discussed herein, there is provided an air conditioning control system, including an electronic apparatus having an intake surface from which cooling air is taken in and an exhaust surface from which the cooling air is discharged, a flow path through which the cooling air discharged from the exhaust surface is returned to the intake surface, a damper which is provided in the flow path, an opening extent of the damper being adjustable, a temperature measuring unit that measures a real temperature of the cooling air at the intake surface, a humidity measuring unit that measures a real humidity of the cooling air at the intake surface, a target value changing unit that changes a target temperature of the real temperature in accordance with a value of the real temperature, and also changes a target humidity of the real humidity in accordance with a value of the real humidity, and a controlling unit that predicts a predicted temperature of the real temperature in a future and a predicted humidity of the real humidity in the future, where the controlling unit controlling the opening extent of the damper such that the predicted temperature becomes close to the target temperature and a predicted humidity becomes close to the target humidity, wherein the target value changing unit sets the target temperature and the target humidity such that the real temperature and the real humidity are raised and lowered in opposite directions.

According to another aspect discussed herein, there is provided an air conditioning control method, the method including measuring, by a temperature measuring unit, a real temperature of cooling air that is taken into an electronic apparatus from an intake surface of the electronic apparatus, measuring, by a humidity measuring unit, a real humidity of the cooling air, changing, by a target value changing unit, a target temperature of the real temperature in accordance with a value of the real temperature, and changing a target humidity of the real humidity in accordance with a value of the real humidity, and adjusting, by a control unit, an opening extent of a damper provided in a flow path through which the cooling air discharged from an exhaust surface of the electronic apparatus is returned to the intake surface, where the opening extent being adjusted, by predicting a predicted temperature of the real temperature in a future and a predicted humidity of the real humidity in the future, such that the predicted temperature becomes close to the target temperature and the predicted humidity becomes close to the target humidity, wherein in the changing the target temperature and the target humidity, the target value changing unit sets the target temperature and the target humidity such that the real temperature and the real humidity are raised and lowered in opposite directions.

The object and advantages of the invention will be realized and attained by means of the elements and combinations particularly pointed out in the claim.

It is to be understood that both the forgoing general description and the following detailed description are exemplary and explanatory and are not restrictive of the invention.

### BRIEF DESCRIPTION OF THE DRAWINGS

FIG. 1 is a schematic top view of a datacenter used for consideration;

FIG. 2 is a schematic side view of the datacenter used for the consideration;

FIG. 3A is a graph obtained by studying the relationship between the time elapsed after start of control on damper, and real humidity in the datacenter in FIG. 1;

FIG. 3B is a graph obtained by studying the relationship between the time elapsed after start of the control on the damper, and the opening extent of the damper in the datacenter in FIG. 1;

FIG. 4 is a functional block diagram of an air conditioning control system according to an embodiment;

FIG. 5 is a flowchart illustrating an air conditioning control method according to this embodiment;

FIG. 6A is a graph illustrating the relationship between the time elapsed after start of control, and the opening extent of damper according to this embodiment;

FIG. 6B is a graph illustrating the relationship between the elapsed time and the real temperature of cooling air at an intake surface according to this embodiment;

FIG. 6C is a graph illustrating the relationship between the elapsed time and the real humidity of the cooling air at the intake surface according to this embodiment;

FIG. 7 is a flowchart illustrating a method of changing a target temperature and a target humidity with a target value changing unit according to this embodiment (part 1);

FIG. 8 is a flowchart illustrating the method of changing the target temperature and the target humidity with the target value changing unit according to this embodiment (part 2);

FIG. 9 is a flowchart illustrating the method of changing the target temperature and the target humidity with the target value changing unit according to this embodiment (part 3);

FIG. 10A is a graph obtained by studying the relationship between the time elapsed after start of the control on the damper, and the real temperature of the cooling air at the intake surface in this embodiment;

FIG. 10B is a graph obtained by studying the relationship between the elapsed time and the real humidity of the cooling air at the intake surface in this embodiment;

FIG. 10C is a graph obtained by studying the relationship between the elapsed time and the opening extent of the damper in this embodiment;

FIG. 11A is a graph obtained by studying the relationship between the time elapsed after start of the control on the damper, and the real humidity of the cooling air at the intake surface in this embodiment; and

FIG. 11B is a graph obtained by studying the relationship between the elapsed time and the opening extent of the damper.

### DESCRIPTION OF EMBODIMENT

Prior to describing an embodiment, matters that the inventor of this application considered will be described.

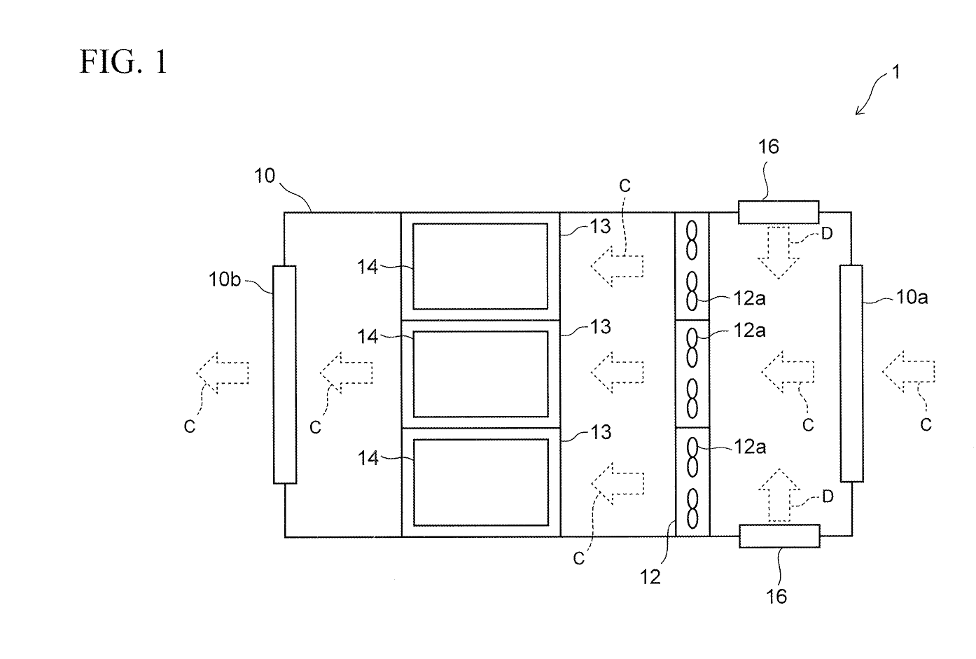

FIG. 1 is a schematic top view of a datacenter used for that consideration.

This datacenter 1 is a module-type datacenter configured to taken in external air as cooling air, and includes a cuboidal container 10.

In the container 10, there are provided a fan unit 12 and a plurality of racks 13 housing electronic apparatuses 14 such as servers.

Among the two opposite faces of the container 10, an air intake opening 10a is provided at one face, while an air exhaust opening 10b is provided at the other face.

The fan unit 12 includes a plurality of fans 12a. By rotating the fans 12a, the fans 12a take external air into the container 10 from the air intake opening 10a and generate cooling air C from the external air.

The cooling air C cools the electronic apparatuses 14. After that, the cooling air C is discharged from the air exhaust opening 10b.

Further, evaporative cooler 16 are provided between the fan unit 12 and the air intake opening 10a.

The evaporative cooler 16 are configured to bring external air into contact with an unillustrated element containing moisture to thereby generate air D lower in temperature than the external air, and supply the air D to the fan unit 12. Moreover, the humidity of the air D is made higher than that of the external air by the moisture of the element.

By using the air D which differs from the external air in temperature and humidity in this manner, it is possible to widen the ranges of adjustment of the temperature and humidity of the cooling air C.

Note that the evaporative cooler 16 may be omitted in some cases.

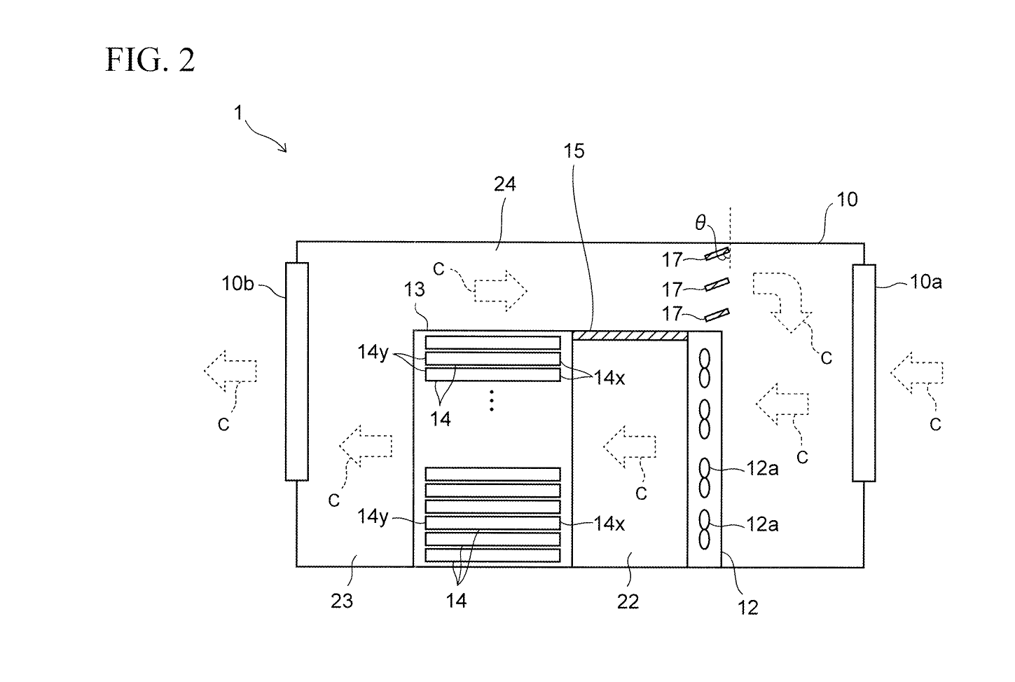

FIG. 2 is a schematic side view of the datacenter 1.

Note that the same elements in FIG. 2 as those described with reference to FIG. 1 are denoted by the same reference numerals as those in FIG. 1, and description thereof is omitted below.

As illustrated in FIG. 2, each electronic apparatus 14 has an intake surface 14x and an exhaust surface 14y. The cooling air C is taken into each electronic apparatus 14 from the intake surface 14x and then discharged from the exhaust surface 14y.

Moreover, the space between the fan unit 12 and the racks 13 serves as a cold isle 22, while the space between the racks 13 and the air exhaust opening 10b serves as a hot isle 23.

A partition plate 15 is provided above the cold isle 22. Moreover, this partition plate 15, the upper faces of the racks 13, and the ceiling surface of the container 10 define a flow path 24.

In this way, part of the warm cooling air C discharged from each electronic apparatus 14 flows through the flow path 24 and returns to the intake surface 14y of the electronic apparatus 14.

Provided at an end of the flow path 24 is damper 17 whose opening extent is adjustable. The definition of the opening extent is not particularly limited. Let 0°-θₘₐₓ be the range in which an inclination angle θ of each damper 17 can be laid. Note that the angle θ is measured form the vertical direction. Then, by making correspondence between the range 0°-θₘₐₓ and the range 0%-100% of the opening extent u, the opening extent u is associated with the angle θ in the following.

By adjusting the opening extent u of the damper 17, it is possible to adjust the flow rate of the warm cooling air C passing through the flow path 24, and thereby adjust the temperature and humidity of the cooling air C to be supplied to the intake surface 14x.

For example, by increasing the opening extent u of the damper 17, the warm cooling air C is supplied more to the intake surface 14x from the flow path 24. Thus, the temperature of the cooling air C at the intake surface 14x can be raised.

Moreover, since temperature and humidity have a negative correlation with each other, the humidity of the cooling air C at the intake surface 14x can be lowered as well.

On the other hand, in order to lower the temperature of the cooling air C at the intake surface 14x and to raise the humidity of the cooling air C at the intake surface 14x, the opening extent u of the damper 17 may be reduced instead.

Next, a method of adjusting the opening extent u of the damper 17 is discussed.

For each electronic apparatus 14, allowable ranges are sometimes set for a real temperature T_{ca} and a real humidity H_{ca} of the cooling air C to be taken from the intake surface 14x.

In the following, the upper and lower limits in the allowable temperature range will be described as Tₘₐₓ₀ and Tₘᵢₙ₀, respectively. Also, the upper and lower limits in the allowable humidity range will be described as Hₘₐₓ₀ and Hₘᵢₙ₀, respectively.

In order to keep the real temperature T_{ca} and the real humidity H_{ca} within the above-mentioned allowable ranges, it is required to adjust the opening extent u of the damper 17 in such a manner that the relations Tₘᵢₙ₀<T_{ca}<Tₘₐₓ₀ and Hₘᵢₙ₀<H_{ca}<Hₘₐₓ₀ hold.

In this example, the opening extent u of the damper 17 is adjusted by switching between two modes. One of the modes is a temperature control mode for controlling only the real temperature T_{ca}, and the other mode is a humidity control mode for controlling only the real humidity H_{ca}.

Here, the temperature control mode is a mode for controlling the opening extent u of the damper 17 such that the real temperature T_{ca} satisfies the relation Tₘᵢₙ₀<T_{ca}<Tₘₐₓ₀. In this mode, a PID controller controls the opening extent u of the damper 17 such that the real temperature T_{ca} becomes equal to a target temperature, and the PID controller does not control the real humidity H_{ca}.

On the other hand, the humidity control mode is a mode for adjusting the opening extent u of the damper 17 such that the real humidity H_{ca} satisfies the relation Hₘᵢₙ₀<H_{ca}<Hₘₐₓ₀. In this mode, the PID controller controls the opening extent u of the damper 17 such that the real humidity H_{ca} becomes equal to a target humidity, and the PID controller does not control the real temperature T_{ca}.

Which modes is to be selected is determined based on the real temperature T_{ca} and the real humidity H_{ca}. For example, if the real temperature T_{ca} is about to be out of the allowable range, the temperature control mode is selected in order to place priority on controlling the real temperature T_{ca}. On the other hand, if the real humidity H_{ca} is about to be out of the allowable range, the humidity control mode is selected in order to place priority on controlling the real humidity H_{ca}.

By selecting between the temperature control mode and the humidity control mode in this manner, it is possible to the keep the real temperature T_{ca} and the real humidity H_{ca} within their allowable ranges.

However, according to an examination conducted by the inventor of this application, this method is found to have the following problem.

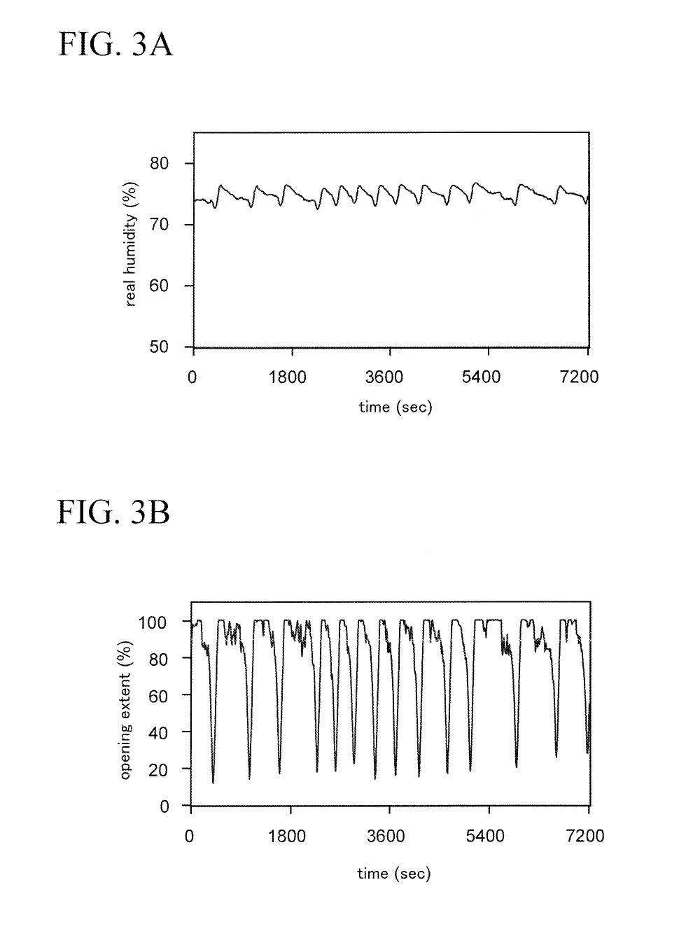

FIG. 3A is a graph obtained by studying the relationship between the time elapsed after starting the control on the damper 17, and the real humidity H_{ca} of the cooling air C at the intake surface 14x.

Moreover, FIG. 3B is a graph obtained by studying the relationship between the time elapsed after starting the control on the damper 17, and the opening extent u of the damper 17.

As illustrated in FIG. 3B, in this control method, the opening extent u of the damper 17 fluctuates greatly. Due to this fluctuation, a hunting phenomenon is occurring in which the real humidity H_{ca} greatly swings as illustrated in FIG. 3A.

The cause of this hunting phenomenon is considered that the opening extent u is adjusted by switching between the temperature control mode and the humidity control mode.

When the opening extent u of the damper 17 greatly changes due to the hunting phenomenon in this manner, the power for driving the damper 17 is wasted, thereby making it difficult to achieve energy saving of the datacenter 1.

### First Embodiment

In this embodiment, the datacenter 1 illustrated in FIG. 1 and FIG. 2 is controlled as follows.

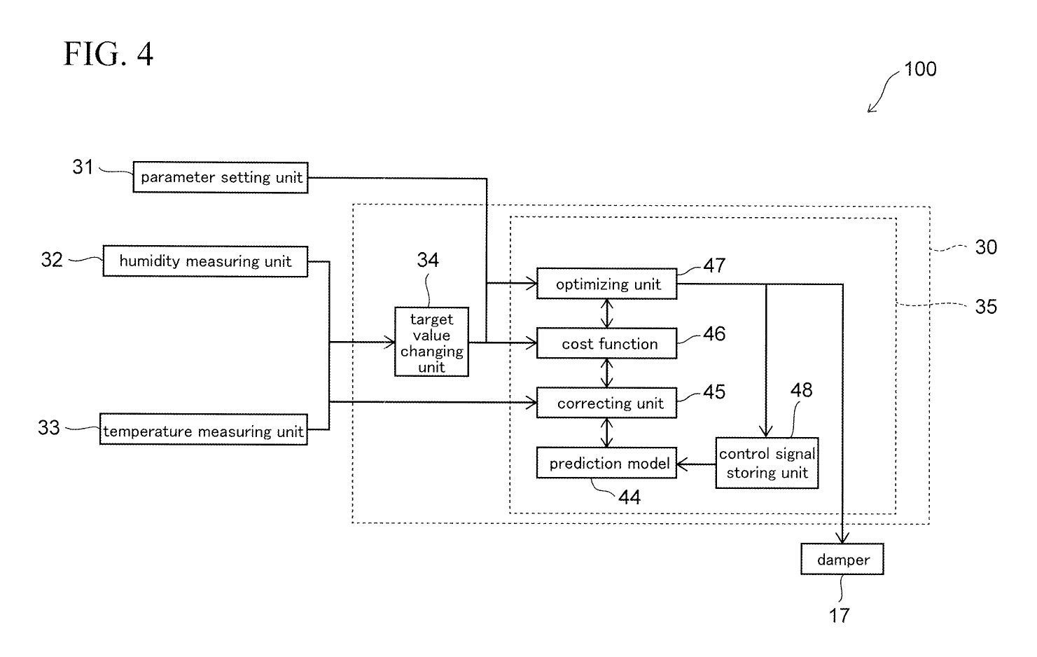

FIG. 4 is a functional block diagram of an air conditioning control system according to this embodiment for controlling the air conditioning of the datacenter 1.

Note that the same elements in FIG. 4 as those described with reference to FIG. 1 and FIG. 2 are denoted by the same reference numerals as those in FIG. 1 and FIG. 2, and description thereof is omitted below.

As illustrated in FIG. 4, an air conditioning control system 100 includes a parameter setting unit 31, a humidity measuring unit 32, a temperature measuring unit 33, and a controlling unit 30.

The parameter setting unit 31 is configured to store various control parameters to be used to control the opening extent of the damper 17.

The humidity measuring unit 32 is configured to measure the real humidity H_{ca} of the cooling air C at the intake surface 14x (see FIG. 2) of each electronic apparatus 14 and transfer the measurement result to the controlling unit 30.

Moreover, the temperature measuring unit 33 is configured to measure the real temperature T_{ca} of the cooling air C at the intake surface 14x of each electronic apparatus 14 and transfer the measurement result to the controlling unit 30.

The number of humidity measuring units 32 is not particularly limited. The largest value of the humidity measured by a plurality of humidity measuring units 32 may be transferred as the real humidity H_{ca} to the controlling unit 30. Likewise, the largest value of the temperature measured by a plurality of temperature measuring units 33 may be transferred as the real temperature T_{ca} to the controlling unit 30.

On the other hand, the controlling unit 30 is, any one of a microcomputer, a field programmable gate array (FPGA), and a programmable logic controller (PLC) for example, and includes a target value changing unit 34 and a model predicting unit 35.

Note that a specific electronic apparatus 14 in a rack 13 may be used as the controlling unit 30 by loading a dedicated program onto that electronic apparatus 14.

The target value changing unit 34 is configured to set a target temperature r₁ and a target humidity r₂ of the cooling air C at the intake surface 14x. Moreover, the target value changing unit 34 changes the target temperature r₁ and the target humidity r₂ in accordance with the values of the real temperature T_{ca} and the real humidity H_{ca} respectively, and outputs these values r₁ and r₂ to the model predicting unit 35. How to change the target temperature r₁ and the target humidity r₂ will be described later.

Note that the target temperature r₁ and the target humidity r₂ will also be described below in a vector notation as in the equation (1) given below:

$$r = [ \begin{matrix}{r}_{1} \\ {r}_{2}\end{matrix} ] . \qquad ( 1 )$$

Moreover, the model predicting unit 35 includes a prediction model 44, a correcting unit 45, a cost function 46, an optimizing unit 47, and a control signal storing unit 48.

Among them, the prediction model 44 is configured to predict a predicted temperature \tilde{y}₁ of the real temperature T_{ca} and a predicted humidity \tilde{y}₂ of the real humidity H_{ca} in a future based on the opening extent u of the damper 17.

Note that the above predicted temperature and the predicted humidity will also be described below in a vector notation as in the equation (2) given below:

$$\tilde{y} = [ \begin{matrix}{\tilde{y}}_{1} \\ {\tilde{y}}_{2}\end{matrix} ] \qquad ( 2 )$$

Moreover, the correcting unit 45 is configured to correct this predicted value \tilde{y} so as to bring it close to the real temperature and humidity of the cooling air C at the intake surface 14x.

Further, the cost function 46 is a function which weights the difference between the predicted value \tilde{y} and the target value r, and its form will be described later.

Furthermore, the optimizing unit 47 is configured to calculate, in a predetermined period of time from the present to a future, a manipulation amount Δu that minimizes the value J of the cost function 46 and satisfies later-described constraint conditions. The manipulation amount Δu thus calculated is output to the control signal storing unit 48 and the damper 17 by the optimizing unit 47.

Moreover, the control signal storing unit 48 is configured to store the past manipulation amount Δu of the opening extent of the damper 17 and output the manipulation amount Δu to the prediction model 44.

Next, an air conditioning control method according to this embodiment will be described.

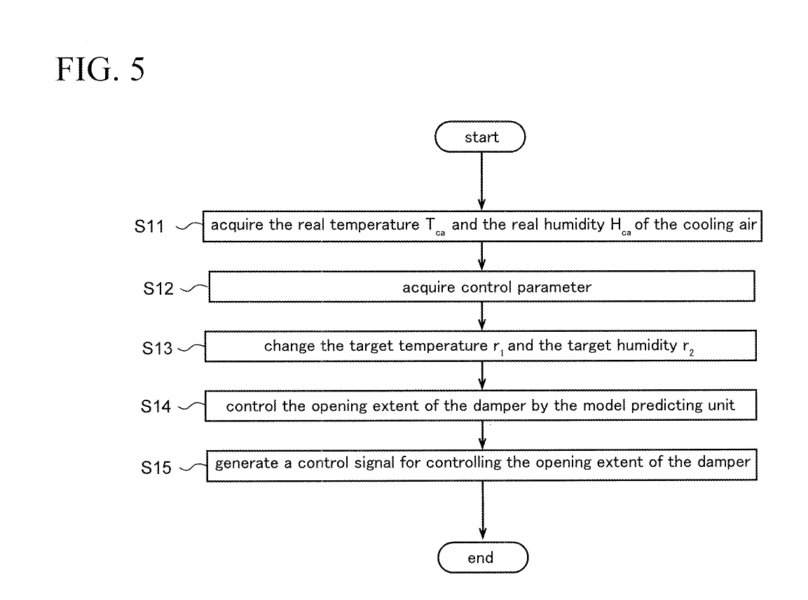

FIG. 5 is a flowchart illustrating the air conditioning control method according to this embodiment.

This flowchart is carried out by the controlling unit 30 in a predetermined control cycle Δt. The control cycle Δt is an integer representing the cycle in which this flowchart is carried out, and is 1 second, for example.

First, in step S11, the controlling unit 30 acquires the real temperature T_{ca} and the real humidity H_{ca} of the cooling air C at the intake surface 14x. Among them, the real temperature T_{ca} is acquired from the temperature measuring unit 33 by the controlling unit 30. Then, the real humidity H_{ca} is acquired from the humidity measuring unit 32 by the controlling unit 30.

Next, the method proceeds to step S12, in which the controlling unit 30 acquires various control parameters from the parameter setting unit 31.

The control parameters include the allowable ranges of each of the real temperature T_{ca} and the real humidity H_{ca}, for example. The allowable ranges are not particularly limited. In the following, the lower limit temperature Tₘᵢₙ₀ of the real temperature T_{ca} is 10° C., and the upper limit temperature Tₘₐₓ₀ of the real temperature T_{ca} is 35° C. Moreover, the lower limit humidity Hₘᵢₙ₀ of the real humidity H_{ca} is 10%, and the upper limit humidity Hₘₐₓ₀ of the real humidity H_{ca} is 85%.

Next, the method proceeds to step S13, in which the target value changing unit 34 changes the target temperature r₁ and the target humidity r₂ in accordance with the values of the real temperature T_{ca} and the real humidity H_{ca}, respectively. How to makes the changes will be described later in detail.

Then, the method proceeds to step S14.

In step S14, the model predicting unit 35 predicts the future predicted temperature \tilde{y}₁ of the real temperature T_{ca} and the future predicted humidity \tilde{y}₂ of the real humidity H_{ca}, and controls the opening extent of the damper 17 such that the real temperature T_{ca} becomes close to the target temperature r₁ and the real humidity H_{ca} becomes close to the target humidity r₂. This control is performed by using a prediction model as follows.

The general equations of this prediction model are described bt the equations (3) and (4) given below:

\tilde{y}₁(k+1)=f₁(u(k)) (3)

\tilde{y}₂(k+1)=f₂(u(k)) (4).

The equation (3) is a temperature prediction model, and the equation (4) is a humidity prediction model. A time point k is included in both prediction models (3) and (4). The time point k is an integer indicating the number of times that the controlling unit 30 carries out the flowchart in FIG. 5. Thus, the equations (3) and (4) are interpreted as the equations to find a temperature y₁ and a humidity y₂ at a future time point k+1 based on an opening extent u(k) of the damper at the time point k.

Note that the equation (3) and the equation (4) are described together in a vector notation as in the equation (5) given below:

$$[ \begin{matrix}{\tilde{y}}_{1} ( k + 1 ) \\ {\tilde{y}}_{2} ( k + 1 )\end{matrix} ] = [ \begin{matrix}{f}_{1} ( u ( k ) ) \\ {f}_{2} ( u ( k ) )\end{matrix} ] . \qquad ( 5 )$$

Further, by collecting the functions f₁ and f₂ into a function f, the equation (5) can be described as the equation (6) given below:

\tilde{y}(k+1)=f(u(k)) (6).

In this embodiment, the general equation (6) is specialized as in the equations (7) and (8) given below:

x(k+1)=Ax(k)+Bᵤu(k) (7)

\tilde{y}(k)=C·x(k) (8).

Note that x(k) in the equations (7) and (8) is a state variable at the time point k and is a n-dimensional (n is a natural number) vector. Moreover, A is an n×n matrix, Bᵤ is an n-dimensional vector, and C is an n-dimensional vector.

Note also that the each components of A, Bᵤ, and C can be found by system identification based on test data such that a predicted value \tilde{y} of the future real temperature and real humidity of the cooling air C can be best approximated. Examples of the system identification include, for example, a prediction error method or a subspace identification method.

Moreover, when it is possible to derive a differential equation of a physics model which expresses the dynamic characteristics of the real temperature and real humidity of the cooling air C, the components of A, Bᵤ, and C can be found by linearizing the differential equation through the Taylor expansion.

Further, it is known that n is determined by an order n_{d1} of the temperature prediction model, dead times dₜ₁, dₜ₂, and an order n_{d2} of the humidity prediction model, and is expressed as n=n_{d1}+dₜ₁+n_{d2}+dₜ₂. The reason for this will be explained in a later-described reference example.

Note that the dead time dₜ₁ is a dead time of the temperature of the cooling air C at the intake surface 14x with respect to the opening extent of the damper 17. The dead time dₜ₂ is a dead time of the humidity of the cooling air C at the intake surface 14x with respect to the opening extent of the damper 17. In this embodiment, the dead times dₜ₁ and dₜ₂ are rounded off to integer values, and the dead times dₜ₁ and dₜ₂ are set to 1 second.

Meanwhile, although a state-space model is used in the above case, the model may be expressed as a multiple regression model or data such as a map function.

Next, the correcting unit 45 corrects the predicted value \tilde{y}(k+1) of the temperature and humidity at the time point k+1 based on the equation (9) given below to calculate a corrected predicted value y(k+1|k):

y(k+1|k)=\tilde{y}(k+1|k)+(yᵣₑₐₗ(k)−y(k|k−1)) (9).

Here,

$$y = [ \begin{matrix}{y}_{1} \\ {y}_{2}\end{matrix} ] , \qquad ( 10 )$$

where y₁ represents the temperature after the correction, and y₂ represents the humidity after the correction.

Further,

$${y}_{real} ( k ) = [ \begin{matrix}{T}_{ca} ( k ) \\ {H}_{ca} ( k )\end{matrix} ] , \qquad ( 11 )$$

where T_{ca}(k) and H_{ca}(k) are the temperature and the humidity at the time point k acquired in step S11, respectively.

In the equation (9) and the subsequent equations, when a variable α at a time point p is to be calculated from information at a time point q, the variable α will be described as α(p|q).

The first term of the right-hand side of the equation (9), \tilde{y}(k+1|k), is the uncorrected predicted value of the temperature and humidity of the cooling air C at the time point k+1.

Moreover, the second term of the right-hand side of the equation (9) is a correction term. y(k|k−1) appearing in the correction term is the predicted value of the temperature and humidity of the cooling air C at the intake surface 14x at the time point k.

At the time point k, the real value is deviated from the predicted value by yᵣₑₐₗ(k)−y(k|k−1). Therefore, by adding yᵣₑₐₗ(k)−y(k|k−1) to the right-hand side of the equation (9), it is possible to prevent the predicted value at the time point k+1 from deviating from the real value.

Note that the above correction may be omitted in some cases.

Here, a future period p is introduced. The future period p is an integer indicating a period of time from the present to a future at which the temperature and humidity of the cooling air C is to be predicted. In the following, the future period p is 100, for example.

Then, the change amount Δu of the opening extent of the damper 17 is defined as in the equation (12) given below:

u(k+i|k)=u(k+i−1|k)+Δu(k+i|k)

(i=0,1, . . . ,p−1) (12).

In the equation (12), i is an index which equally divides the future period p into p parts.

As can be understood from the equation (12), a change amount Δu(k+i|k) is defined by an opening extent u(k+i|k) of the damper 17 at a time point k+i, and an opening extent u(k+i−1|k) of the damper 17 at a time point k+i−1, which is the antecedent time point of k+i by one step.

Moreover, as each opening extent u(k) in the equation (12), those stored in the control signal storing unit 48 can be used.

Note that since the opening extent of the damper 17 is manipulated by the controlling unit 30, the change amount Δu will also be called the manipulation amount Δu in the following.

By using the index i in the equation (12), the equations (7) to (9) mentioned above can be expressed as the equations (13) to (15) given below, respectively:

x(k+i+1|k)=Ax(k+i|k)+Bᵤu(k+i|k) (13),

\tilde{y}(k+i+1|k)=C·x(k+i+1|k) (14),

y(k+i+1|k)=\tilde{y}(k+i+1|k)+(yᵣₑₐₗ(k)−y(k|k−1)) (15).

Further, the allowable ranges of the parameters are defined as in the equations (16) to (19) given below:

Tₘᵢₙ≦y₁(k+i+1|k)≦Tₘₐₓ (16),

Hₘᵢₙ≦y₂(k+i+1|k)≦Hₘₐₓ (17),

Δuₘᵢₙ≦Δu(k+i|k)≦Δuₘₐₓ (18),

uₘᵢₙ≦u(k+i|k)≦uₘₐₓ (19).

The equation (16) defines the allowable range of the temperature y₁ of the cooling air C at the intake surface 14x.

Similarly, the equation (17) defines the allowable range of the humidity y₂ of the cooling air C at the intake surface 14x.

The equation (18) defines the allowable range of the manipulation amount Δu of the damper 17. A minimum value Δuₘᵢₙ and a maximum value Δuₘₐₓ of this allowable range are limit values that the opening extent of the damper 17 can be changed in one manipulation.

Moreover, the equation (19) defines the allowable range of the opening extent u of the damper 17. Uₘᵢₙ and Uₘₐₓ represent the lower limit value and upper limit value of that allowable range, respectively.

The parameters y₁, y₂, Δu, and u are subjected to the constraint conditions of the equations (16) to (19), respectively.

Moreover, in this embodiment, besides the above constraint conditions, the equation (20) given below is provided as another constraint condition on the manipulation amount Δu:

Δu(k+h|k)=0

(h=m, . . . ,p−1) (20).

The equation (20) indicates that the manipulation amount Δu becomes 0 at and after a time point k+m. This is based on an idea that the manipulation amount Δu should gradually approach 0 toward the end of the future period, instead of shifting the manipulation amount Δu suddenly to 0 at the end of the future period.

Meanwhile, the value of m is not particularly limited. In this example, m is set to 1.

Next, the optimizing unit 47 calls the cost function 46 which is described as in the equation (21) given below:

$$J ( k ) = {\sum }_{i = 0}^{p - 1} {[ y ( k + i + 1 \vert k ) - r ( k + i + 1 ) ]}^{T} Q [ y ( k + i + 1 \vert k ) - r ( k + i + 1 ) ] + Δ u ( k + i \vert k ) {R}_{Δ u} Δ u ( k + i \vert k ) + [ u ( k + i \vert k ) - {u}_{target} ( k + i ) ] {R}_{u} [ u ( k + i \vert k ) - {u}_{target} ( k + 1 ) ] . \qquad ( 21 )$$

In the equation (21), Q is a 2×2 matrix representing a weight, and RΔᵤ and Rᵤ are scalars representing weights.

In the first term of the right-hand side of the equation (21), the difference (y₁−r₁) between the predicted temperature y₁ and the target temperature r₁, and the difference (y₂−r₂) between the predicted humidity y₂ and the target humidity r₂ are weighted. This first term represents an operation to bring the temperature y₁ and the humidity y₂, which are control targets, close to their respective target values r₁ and r₂, and the matrix Q is a weight for the operation, i.e. a target value following parameter.

The second term of the right-hand side of the equation (21) represents an operation to bring the change amount Δu of the manipulation amount u close to 0, and RΔᵤ is a weight for this operation, i.e. a manipulation amount reducing parameter. The smaller the RΔᵤ, the larger the change amount Δu, and the larger the RΔᵤ, the smaller the change amount Δu.

The third term of the right-hand side of the equation (21) represents an operation to bring the opening extent u of the damper 17 close to a target opening extent U_{target}. In this embodiment, u_{target} is set to 0. Rᵤ is a weight for the operation to bring the opening extent close to the target opening extent u_{target}, i.e. a manipulation amount shift width parameter.

These control parameters Q, RΔᵤ, and Rᵤ are stored in the parameter setting unit 31 mentioned above, and are acquired by the model predicting unit 35 in step S12 in advance.

Then, the optimizing unit 47 calculates an input sequence of the manipulation amounts Δu which minimize the value J of the cost function 46, based on the equation (22) given below:

$$\{ Δ {u}_{opt} ( k \vert k ) , … , Δ {u}_{opt} ( m - 1 + k \vert k ) \} arg {min}_{Δ u ( k \vert k ) , … , Δ u ( m - 1 + k \vert k )} J ( k ) . \qquad ( 22 )$$

Then, the optimizing unit 47 extracts the first element Δuₒₚₜ(k|k) in the optimum input sequence {Δuₒₚₜ(k|k), . . . , Δuₒₚₜ(m−1+k|k)} calculated from the equation (22).

Further, the optimizing unit 47 calculates the opening extent u(k) of the damper 17 at the time point k from the equation (23) given below:

u(k)=u(k−1)+Δuₒₚₜ(k|k) (23).

The optimizing solver which minimizes the cost function 46 may use a metaheuristic numerical solution which searches for an approximate solution such as an genetic algorithm (GA) or particle swarm optimization (PSO). Note that sequential quadratic programming (SQP) is used in this example to solve a quadratic programming problem.

By the above operation, step S14 ends.

Thereafter, the method proceeds to step S15, in which the controlling unit 30 generates a control signal for controlling the opening extent of the damper 17 and changes the opening extent of the damper 17 to u(k) appearing in the equation (23).

By the above operation, the basic steps of the air conditioning control method according to this embodiment ends.

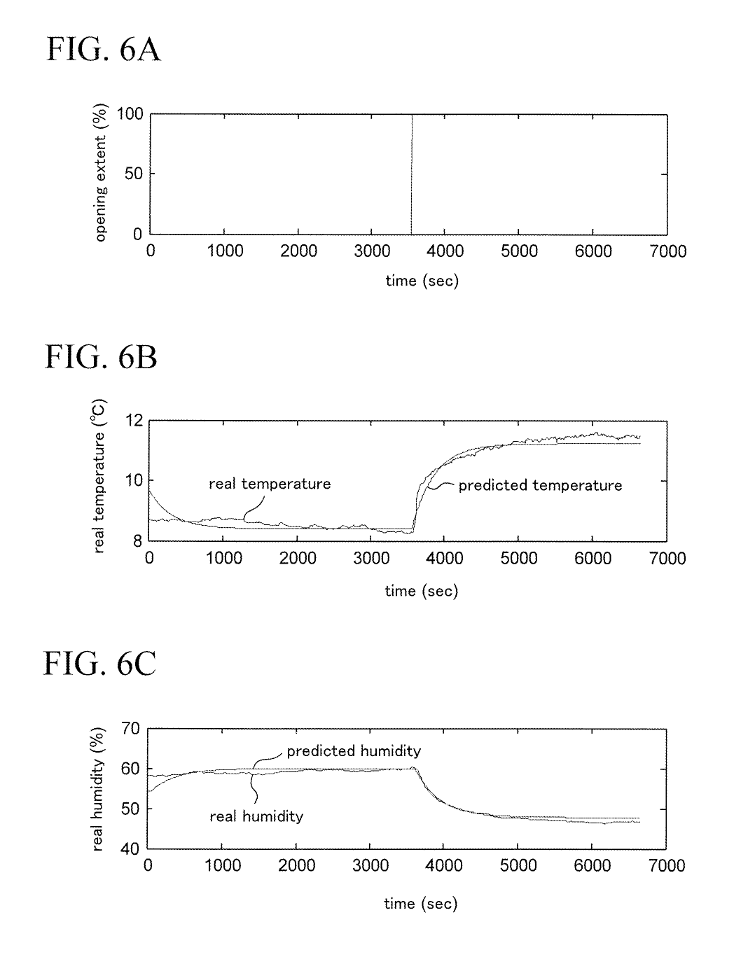

FIGS. 6A to 6C are graphs illustrating one exemplary result that are obtained by controlling the datacenter 1 using the above-described air conditioning control method.

FIG. 6A is a graph illustrating the relationship between the time elapsed after start of the control, and the opening extent of the damper 17.

Further, FIG. 6B is a graph illustrating the relationship between the above elapsed time and the real temperature T_{ca} of the cooling air at the intake surface 14x.

Furthermore, FIG. 6C is a graph illustrating the relationship between the above elapsed time and the real humidity H_{ca} of the cooling air at the intake surface 14x.

As illustrated in FIGS. 6B and 6C, the real temperature T_{ca} and the real humidity H_{ca} substantially match their predicted values.

Next, a method of changing the target temperature r₁ and the target humidity r₂ in the target value changing unit 34 will be described.

In this embodiment, the target temperature r₁ and the target humidity r₂ are not fixed at certain values but are dynamically changed in the following way in accordance with the values of the real temperature T_{ca} and the real humidity H_{ca}, respectively.

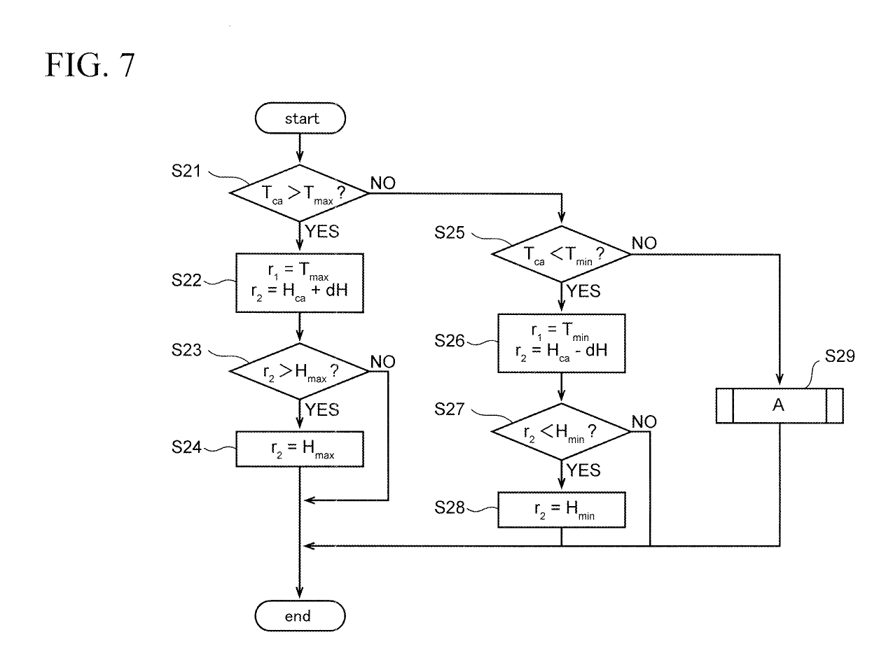

FIGS. 7 to 9 are flowcharts illustrating the method of changing the target temperature r₁ and the target humidity r₂ in the target value changing unit 34.

Here, the definitions of the symbols used in this example are listed below again.

r₁: target temperature

r₂: target humidity

Tₘₐₓ₀: upper limit temperature

Tₘᵢₙ₀: lower limit temperature

Hₘₐₓ₀: upper limit humidity

Hₘᵢₙ₀: lower limit humidity

If the real temperature is too close to the limit value Tₘₐₓ₀ or Tₘᵢₙ₀, the real temperature may exceed or fall below the limit value. To deal with this problem, margins are provided to each of the limit values Tₘₐₓ₀ and Tₘᵢₙ₀ in this example, and the limit values Tₘₐₓ₀ and Tₘᵢₙ₀ thus provided with the margins are employed as new limit values Tₘₐₓ and Tₘᵢₙ as follows:

Tₘₐₓ=Tₘₐₓ₀−m_{T}

Tₘᵢₙ=Tₘᵢₙ₀+m_{T},

where m_{T} is a positive value determined in view of the margin, and m_{T}=1 in this example.

For the same reason, the following new limit values Hₘₐₓ and Hₘᵢₙ are employed for the humidity:

Hₘₐₓ=Hₘₐₓ₀−m_{H}

Hₘᵢₙ=Hₘᵢₙ₀+m_{H},

where m_{H} is a positive value determined in view of the margin, and m_{H}=1 in this example.

Moreover, the smallest unit of change for the target temperature r₁ by the target value changing unit 34 is defined as dT, and the target temperature r₁ is raised or lowered by the unit dT.

Likewise, the smallest unit of change for the target humidity r₂ by the target value changing unit 34 is defined as dH, and the target humidity r₂ is raised or lowered by the unit dH.

In this example, dT=dH=5.

First, in step S21 in FIG. 7, it is determined whether or not the real temperature T_{ca} is higher than the upper limit temperature Tₘₐₓ.

When it is determined that the real temperature T_{ca} is higher than the upper limit temperature Tₘₐₓ (YES), the method proceeds to step S22, in which the real temperature T_{ca} is lowered.

To lower the real temperature T_{ca}, it is only required to change the target temperature r₁ to a lower temperature than the real temperature T_{ca}. In this example, the target temperature r₁ is changed such that r₁=Tₘₐₓ.

Meanwhile, as opposed to the lowering the real temperature T_{ca}, the target humidity r₂ is changed so as to raise the real humidity H_{ca}. In this example, the real humidity H_{ca} is raised by changing the target humidity r₂ such that r₂=H_{ca}+dH.

The real temperature T_{ca} and the real humidity H_{ca} have a negative correlation with each other. Therefore, when the real temperature T_{ca} is desired to be lowered, the target humidity r₂ is changed in the opposite way, i.e. raised. As a result, as the real temperature T_{ca} is lowered, the real humidity H_{ca} is automatically brought close to the target humidity r₂. In this way, the real temperature T_{ca} and the real humidity H_{ca} can be easily brought close to their respective target temperature r₁ and target humidity r₂ through the adjustment of the opening extent of the damper 17.

Then, in order to check whether the target humidity r₂ changed in step S22 is within the allowable range, the method proceeds to step S23, in which it is determined whether or not the target humidity r₂ is higher than the upper limit humidity Hₘₐₓ.

Here, when it is determined that the target humidity r₂ is higher than the upper limit humidity Hₘₐₓ (YES), the method proceeds to step S24.

In step S24, the target humidity r₂ is changed such that r₂=Hₘₐₓ, to thereby bring the target humidity r₂ within the allowable range.

On the other hand, when it is determined in step S23 that the target humidity r₂ is not higher than the upper limit humidity Hₘₐₓ (NO), the method is ended.

Next, the case where it is determined in step S21 that the real temperature T_{ca} is not higher than the upper limit temperature Tₘₐₓ (NO) will be described.

In this case, the method proceeds to step S25, in which it is determined whether or not the real temperature T_{ca} is lower than the lower limit temperature Tₘᵢₙ.

Here, when it is determined that the real temperature T_{ca} is lower than the lower limit temperature Tₘᵢₙ (YES), the method proceeds to step S26, in which the real temperature T_{ca} is raised.

To raise the real temperature T_{ca}, it is only required to change the target temperature r₁ to a higher temperature than the real temperature T_{ca}. In this example, the target temperature r₁ is changed such that r₁=Tₘᵢₙ.

Moreover, as opposed to raising the real temperature T_{ca} in this manner, the target humidity r₂ is changed so as to lower the real humidity H_{ca}. In this example, the real humidity H_{ca} is lowered by changing the target humidity r₂ such that r₂=H_{ca}−dH.

By raising and lowering the real temperature T_{ca} and the real humidity H_{ca} in the opposite directions in this manner, the real temperature T_{ca} and the real humidity H_{ca} can be easily brought close to their respective target temperature r₁ and target humidity r₂ through the adjustment of the opening extent of the damper 17 for the same reason as that for step S22 mentioned above.

Next, to check whether the target humidity r₂ changed in step S26 is within the allowable range, the method proceeds to step S27, in which it is determined whether or not the target humidity r₂ is lower than the lower limit humidity Hₘᵢₙ.

Here, when it is determined that the target humidity r₂ is lower than the lower limit humidity Hₘᵢₙ (YES), the method proceeds to step S28.

In step S28, the target humidity r₂ is changed such that r₂=Hₘᵢₙ, to thereby bring the target humidity r₂ within the allowable range.

On the other hand, when it is determined in step S27 that the target humidity r₂ is not lower than the lower limit humidity Hₘᵢₙ (NO), the method is ended.

Next, the case where it is determined in step S25 that the real temperature T_{ca} is not lower than the lower limit temperature Tₘᵢₙ (NO) will be described.

In this case, the method proceeds to a subroutine A of step S29.

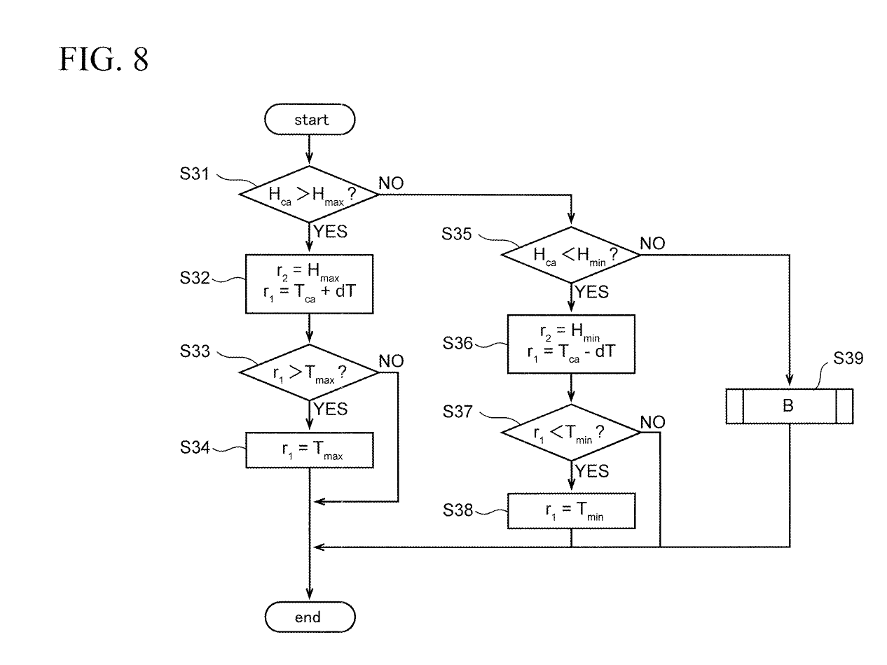

FIG. 8 is a flowchart illustrating the content of processing in the subroutine A.

First, in step S31, it is determined whether or not the real humidity H_{ca} is higher than the upper limit humidity Hₘₐₓ.

Here, when it is determined that the real humidity H_{ca} is higher than the upper limit humidity Hₘₐₓ (YES), the method proceeds to step S32, in which the real humidity H_{ca} is lowered.

To lower the real humidity H_{ca}, it is only required to change the target humidity r₂ to a lower humidity than the real humidity H_{ca}. In this example, the target humidity r₂ is changed such that r₂=Hₘₐₓ.

Moreover, as opposed to lowering the real humidity H_{ca} in this manner, the target temperature r₁ is changed so as to raise the real temperature T_{ca}. In this example, the real temperature Tₘₐ is raised by changing the target temperature r₁ such that r₁=T_{ca}+dH.

As mentioned above, the real temperature T_{ca} and the real humidity H_{ca} have a negative correlation with each other. For this reason, when the real humidity H_{ca} is desired to be lowered, the target temperature r₁ is changed in the opposite way, i.e. raised. Thus, as the real humidity H_{ca} is lowered, the real temperature T_{ca} is automatically brought close to the target temperature r₁. In this way, the real temperature T_{ca} and the real humidity H_{ca} can be easily brought close to their respective target temperature r₁ and target humidity r₂ through the adjustment of the opening extent of the damper 17.

Next, to check whether the target temperature r₁ changed in step S32 is within the allowable range, the method proceeds to step S33, in which it is determined whether or not the target temperature r₁ is higher than the upper limit temperature Tₘₐₓ

Here, when it is determined that the target temperature r₁ is higher than the upper limit temperature Tₘₐₓ (YES), the method proceeds to step S34.

In step S34, the target temperature r₁ is changed such that r₁=Tₘₐₓ, to thereby bring the target temperature r₁ within the allowable range.

On the other hand, when it is determined in step S33 that the target temperature r₁ is not higher than the upper limit temperature Tₘₐₓ (NO), the method is ended.

Next, the case where it is determined in step S31 described above that the real humidity H_{ca} is not higher than the upper limit humidity Hₘₐₓ (NO) will be described.

In this case, the method proceeds to step S35, in which it is determined whether or not the real humidity H_{ca} is lower than the lower limit humidity Hₘᵢₙ.

Here, when it is determined that the real humidity H_{ca} is lower than the lower limit humidity Hₘᵢₙ (YES), the method proceeds to step S36, in which the real humidity H_{ca} is raised.

To raise the real humidity H_{ca}, it is only required to change the target humidity r₂ to a higher humidity than the real humidity H_{ca}. In this example, the target humidity r₂ is changed such that r₂=Hₘᵢₙ.

Moreover, as opposed to raising the real humidity H_{ca} in this manner, the target temperature r₁ is changed so as to lower the real temperature T_{ca}. In this example, the real temperature T_{ca} is lowered by changing the target temperature r₁ such that r₁=T_{ca}−dT.

By raising and lowering the real temperature T_{ca} and the real humidity H_{ca} in the opposite directions in this manner, the real temperature T_{ca} and the real humidity H_{ca} can be easily brought close to their respective target temperature r₁ and target humidity r₂ through the adjustment of the opening extent of the damper 17 as in the case of step S32 mentioned above.

Then, to check whether the target temperature r₁ changed in step S36 is within the allowable range, the method proceeds to step S37, in which it is determined whether or not the target temperature r₁ is lower than the lower limit temperature Tₘᵢₙ.

Here, when it is determined that the target temperature r₁ is lower than the lower limit temperature Tₘᵢₙ (YES), the method proceeds to step S38.

In step S38, the target temperature r₁ is changed such that r₁=Tₘᵢₙ, to thereby bring the target temperature r₁ within the allowable range.

On the other hand, if it is determined in step S37 that the target temperature r₁ is not lower than the lower limit temperature Tₘᵢₙ (NO), the method is ended.

Next, the case where it is determined in step S35 that the real humidity H_{ca} is not lower than the lower limit humidity Hₘᵢₙ (NO) will be described.

In this case, the method proceeds to a subroutine B of step S39.

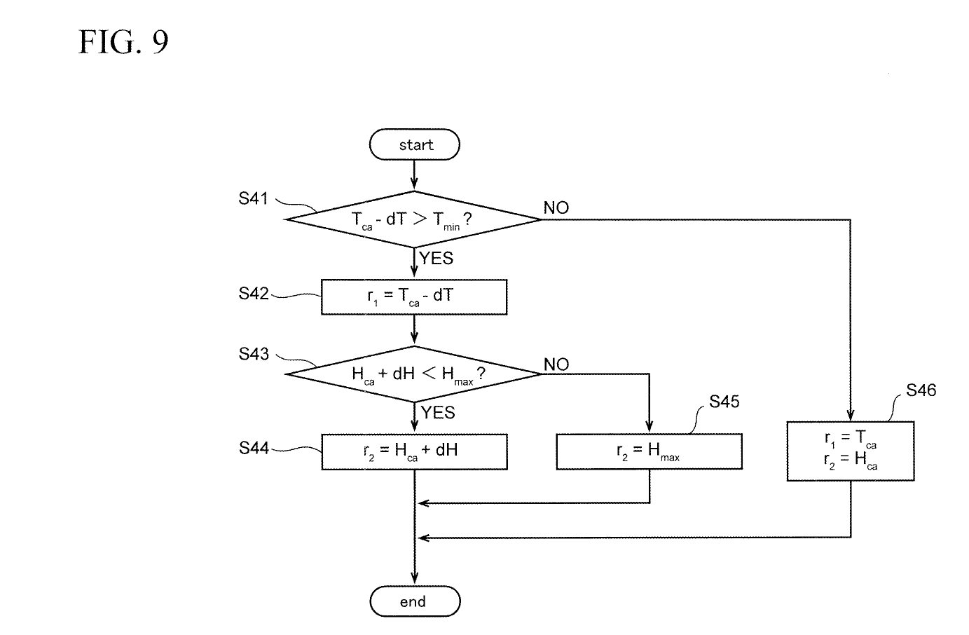

FIG. 9 is a flowchart illustrating the content of processing in the subroutine B.

In the subroutine B, the target temperature r₁ is lowered as much as possible within the allowable range in the following way.

First, in step S41, it is determined whether or not there is still room to further lower the real temperature T_{ca} in the allowable range.

As mentioned above, the smallest unit of lowering the temperature is dT. Therefore, in this step, decision is made on whether or not there is still room to lower the real temperature T_{ca}, by determining whether or not T_{ca}−dT is larger than the lower limit temperature Tₘᵢₙ.

Here, when it is determined that T_{ca}−dT is larger than the lower limit temperature Tₘᵢₙ (YES), it is decided that there is still room to lower the real temperature T_{ca}, and the method proceeds to step S42.

In step S42, the target temperature r₁ is lowered by changing the target temperature r₁ to T_{ca}−dT.

Then, the method proceeds to step S43, in which it is decided whether there is still room to further raise the real humidity H_{ca} in the allowable range.

As mentioned above, the smallest unit of raising the humidity is dH. Therefore, in this step, decision is made on whether or not there is still room to raise the real humidity H_{ca}, by determining whether or not H_{ca}+dH is smaller than the upper limit humidity Hₘₐₓ.

Here, when it is determined that H_{ca}+dH is smaller than the upper limit humidity Hₘₐₓ (YES), it is decided that there is still room to raise the real humidity H_{ca}, and the method proceeds to step S44.

In step S44, the target humidity r₂ is changed to H_{ca}+dH.

On the other hand, when it is determined in step S43 that H_{ca}+dH is not smaller than the upper limit humidity Hₘₐₓ (NO), there is no room to raise the real humidity H_{ca}.

Therefore, in this case, the method proceeds to step S45, in which the target humidity r₂ is set to the upper limit humidity Hₘₐₓ so as to raise the humidity as much as possible within the allowable range.

Further, when it is determined in step S41 that T_{ca}−dT is not larger than the lower limit temperature Tₘᵢₙ (NO), the method proceeds to step S46.

In this case, there is no room to lower the real temperature T_{ca}. Therefore, the target temperature r₁ and the target humidity r₂ are changed such that r₁=T_{ca} and r₂=H_{ca}, so as to maintain the real temperature T_{ca} and the real humidity H_{ca} at their current values.

By the above operation, the basic steps of the method of changing the target temperature r₁ and the target humidity r₂ in the target value changing unit 34 end.

After that, the flowcharts in FIGS. 7 to 9 are repeated in the predetermined control cycle. Thus, each time step S42 in FIG. 9 is performed, the target temperature r₁ is lowered by dT, and hence the target temperature r₁ is changed to a temperature closer to the lower limit temperature Tₘᵢₙ than to the upper limit temperature Tₘₐₓ.

By lowering the target temperature r₁ as much as possible within a range within which the target temperature r₁ does not lower than the lower limit temperature Tₘᵢₙ in this manner, it is possible to efficiently cool the electronic apparatuses 14 with the cooling air C of the real temperature T_{ca} which is low and close to the lower limit temperature Tₘᵢₙ.

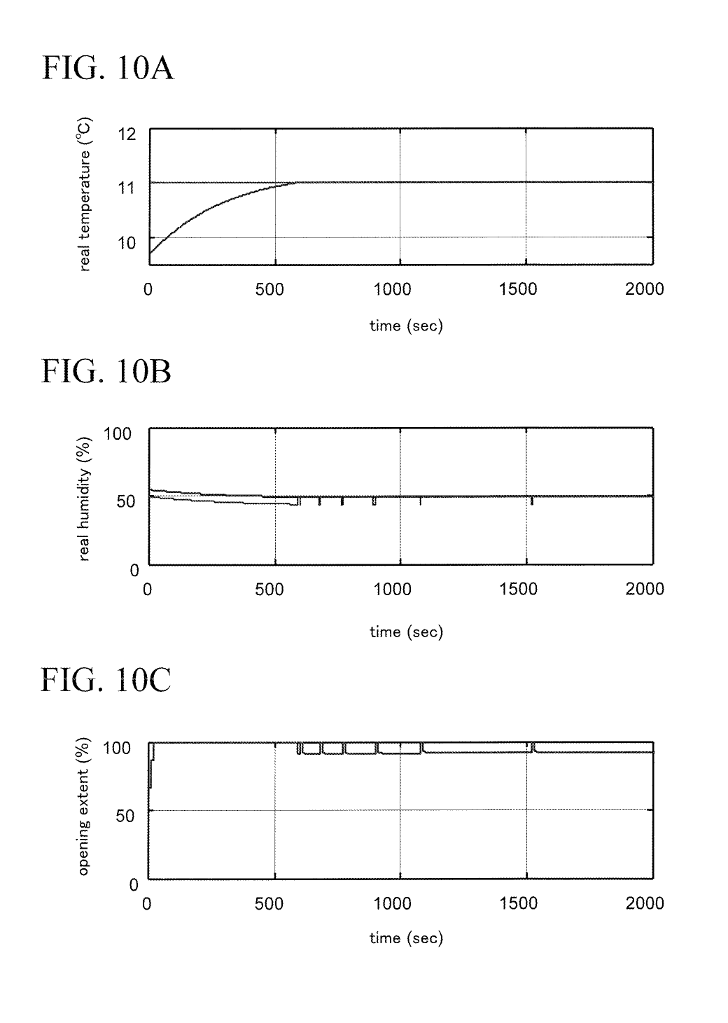

The inventor of this application conducted an examination to check whether the real temperature T_{ca} of the cooling air C could be maintained at and around the lower limit temperature Tₘᵢₙ. As a result, graphs in FIGS. 10A to 10C were obtained.

FIG. 10A is a graph obtained by studying the relationship between the time elapsed after start of the control of the damper 17, and the real temperature T_{ca} of the cooling air C at the intake surface 14x.

Moreover, FIG. 10B is a graph obtained by studying the relationship between the time elapsed after the start of the control of the damper 17, and the real humidity H_{ca} of the cooling air C at the intake surface 14x.

Furthermore, FIG. 10C is a graph obtained by studying the relationship between the time elapsed after the start of the control of the damper 17, and the opening extent of the damper 17.

In this examination, parameters were set as follows:

Tₘₐₓ₀=35° C.

Tₘᵢₙ₀=10° C.

Hₘₐₓ₀=85%

Hₘᵢₙ₀=10%

dT=dH=1

Tₘₐₓ=Tₘₐₓ₀−dT=34° C.

Tₘᵢₙ=Tₘᵢₙ₀+dT=11° C.

Hₘₐₓ=Hₘₐₓ₀−dH=84%

Hₘᵢₙ=Hₘᵢₙ₀+dH=11%.

As illustrated in FIG. 10A, the real temperature T_{ca} was maintained at the lower limit temperature Tₘᵢₙ (11° C.). From this result, it was confirmed that the real temperature T_{ca} of the cooling air C could be maintained at and around the lower limit temperature Tₘᵢₙ by following the flowchart in FIG. 9.

Moreover, in step S42 and step S44 mentioned above, the target temperature r₁ and the target humidity r₂ are changed such that the target temperature and the target humidity are raised and lowered in opposite directions each other. Since temperature and humidity have a negative correlation with each other, both the real temperature T_{ca} and the real humidity H_{ca} can be easily brought close to their target values r₁ and r₂ by raising and lowering these target values in the opposite directions in this manner.

According to this embodiment described above, in step S22 in FIG. 7, the target value changing unit 34 sets the target temperature r₁ and the target humidity r₂ such that the real temperature T_{ca} and the real humidity H_{ca} can be raised and lowered in the opposite directions. This is also the case in step S26, step S32, and step S36.

Thus, both the real temperature T_{ca} and the real humidity H_{ca} can be easily brought close to their target values as mentioned above.

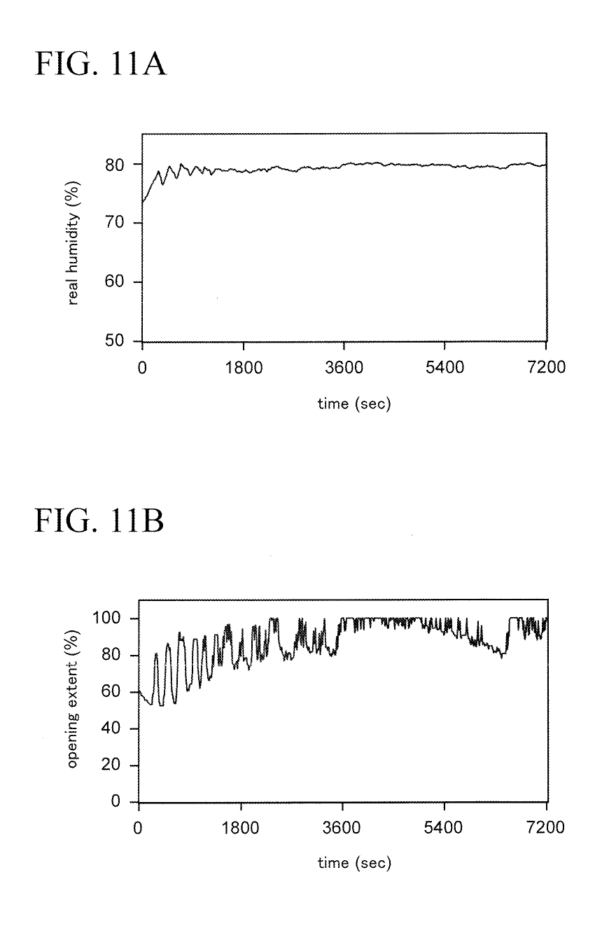

Next, the inventor of this application conducted an examination on advantageous effects obtained by setting the target temperature r₁ and the target humidity r₂ such that the real temperature T_{ca} and the real humidity H_{ca} can be raised and lowered in the opposite directions as described above. As a result, graphs in FIGS. 11A and 11B were obtained.

FIG. 11A is a graph obtained by studying the relationship between the time elapsed after the start of the control of the damper 17, and the real humidity H_{ca} of the cooling air C at the intake surface 14x.

Moreover, FIG. 11B is a graph obtained by studying the relationship between the time elapsed after the start of the control of the damper 17, and the opening extent of the damper 17.

As illustrated in FIG. 11A, the real humidity H remained stable and did not largely fluctuate as in the case of FIG. 3A.

Moreover, as illustrated in FIG. 11B, no large fluctuations were observed in the opening extent of the damper 17, which indicates that any noticeable hunting phenomenon as that in FIG. 3B did not occur.

From these results, it was confirmed that the hunting phenomenon could be effectively suppressed by setting the target temperature r₁ and the target humidity r₂ such that the real temperature T_{ca} and the real humidity H_{ca} could be raised and lowered in the opposite directions as in this embodiment.

The reason for this is considered that, unlike the example of FIGS. 3A and 3B in which the switching between the temperature control mode and the humidity control mode is performed, the target temperature r₁ and the target humidity r₂ are changed as a whole in the present embodiment. Namely, in the present embodiment, the target temperature r₁ and the target humidity r₂ are raised and lowered in opposite directions each other in accordance with their negative correlation.

Since the hunting phenomenon of the damper 17 can be suppressed as described above, the power consumption of the damper 17 can be reduced, thereby making it possible to achieve energy saving of the datacenter 1.

Although the present embodiment is described above in detail, the present embodiment is not limited to the above.

For example, although the air conditioning control method for the datacenter 1 is described above, this embodiment may be applied to the air conditioning of facilities including heat generating parts.

### Reference Example

In step S14 (see FIG. 5) of this embodiment, it is mentioned that the dimension n of the state variable x(k), the order n_{d1} of the temperature prediction model, the dead times dₜ₁ and dₜ₂, and the order n_{d2} of the humidity prediction model satisfy the relation n=n_{d1}+dₜ₁+n_{d2}+dₜ₂. The reason for this will be described below.

First, consider the state-space model of discrete time represented by the following equation (24). Note that the number of the input parameter and the output parameter of this model is one, and dimension of this model is one.

x(k+1)=Ax(k)+Bu(k)

y(k)=Cx(k)

A=[a]

B=[b]

C=[c]

x(0)=x₁(0) (24)

Here, in the case where the dead time of an input u is 1 second and the cycle of k is 1 second, the model can be expressed such that, like the equation (25) given below, the value of the input u is stored in the second component of the state variable and shifted to the first row in the next cycle.

$$x ( k + 1 ) = Ax ( k ) + Bu ( k ) \\ y ( k ) = Cx ( k ) \\ x ( 0 ) = [ \begin{matrix}{x}_{1} ( 0 ) \\ 0\end{matrix} ] , A = [ \begin{matrix}a & b \\ 0 & 0\end{matrix} ] , B = [ \begin{matrix}0 \\ 1\end{matrix} ] , C = [ c ] . \qquad ( 25 )$$

In the example of the equation (25), the order of the state variable is 2, which is the sum of 1 as the model order and 1 as a value taking into consideration of the dead time.

Moreover, in the case where the dead time of the input u is 2 seconds, the model can be expressed such that, like the equation (26) given below, the second component and the third component of the state variable and the value of the input u are shifted, as in the above case.

$$x ( k + 1 ) = Ax ( k ) + Bu ( k ) \\ y ( k ) = Cx ( k ) \\ x ( 0 ) = [ \begin{matrix}{x}_{1} ( 0 ) \\ 0 \\ 0\end{matrix} ] , A = [ \begin{matrix}a & 0 & b \\ 0 & 0 & 0 \\ 0 & 1 & 0\end{matrix} ] , B = [ \begin{matrix}0 \\ 1 \\ 0\end{matrix} ] , C = [ c 0 \; 0 ] \qquad ( 26 )$$

In the example of the equation (26), the order of the state variable is 3, which is the sum of 1 as the model order and 2 as a value taking into consideration the dead time.

In the case where the dead time of the input u is 3 seconds, the model can be expressed such that, like the equation (27) given below, the second component, the third component, and the fourth component of the state variable and the value of the input u are shifted, as in the above cases.

$$x ( k + 1 ) = Ax ( k ) + Bu ( k ) \\ y ( k ) = Cx ( k ) \\ x ( 0 ) = [ \begin{matrix}{x}_{1} ( 0 ) \\ 0 \\ 0 \\ 0\end{matrix} ] , A = [ \begin{matrix}a & 0 & 0 & b \\ 0 & 0 & 0 & 0 \\ 0 & 1 & 0 & 0 \\ 0 & 0 & 1 & 0\end{matrix} ] , B = [ \begin{matrix}0 \\ 1 \\ 0 \\ 0\end{matrix} ] , C = [ c 0 \; 0 \; 0 ] \qquad ( 27 )$$

In the example of the equation (27), the order of the state variable is 4, which is the sum of 1 as the model order and 3 as a value taking into consideration the dead time.

Next, consider the state-space model of discrete time represented by the following equation (28). Note that the number of the input parameter and the output parameter of this model is one, and dimension of this model is two.

$$x ( k + 1 ) = Ax ( k ) + Bu ( k ) \\ y ( k ) = Cx ( k ) \\ A = [ \begin{matrix}{a}_{11} & {a}_{12} \\ {a}_{21} & {a}_{22}\end{matrix} ] \\ B = [ \begin{matrix}{b}_{1} \\ {b}_{2}\end{matrix} ] \\ C = [ {c}_{1} {c}_{2} ] \\ x ( 0 ) = [ \begin{matrix}{x}_{1} ( 0 ) \\ {x}_{2} ( 0 )\end{matrix} ] \qquad ( 28 )$$

Here, in the case where the dead time of the input u is 1 second and the cycle of k is 1 second, the model can be expressed such that, like the equation (29) given below, the value of the input u is stored in the third component of the state variable and shifted to the first row and the second row in the next cycle.

$$x ( k + 1 ) = Ax ( k ) + Bu ( k ) \\ y ( k ) = Cx ( k ) \\ x ( 0 ) = [ \begin{matrix}{x}_{1} ( 0 ) \\ {x}_{2} ( 0 ) \\ 0\end{matrix} ] , \\ A = [ \begin{matrix}{a}_{11} & {a}_{12} & {b}_{1} \\ {a}_{21} & {a}_{22} & {b}_{2} \\ 0 & 0 & 0\end{matrix} ] , \\ B = [ \begin{matrix}0 \\ 0 \\ 1\end{matrix} ] , \\ C = [ {c}_{1} {c}_{2} 0 ] \qquad ( 29 )$$

Thus, the order of the state variable is 3, which is the sum of 2 as the model order and 1 as a value taking into consideration the dead time.

Moreover, in the case where the dead time of the input u is 2 seconds and the cycle of k is 1 second, the model can be expressed such that, like the equation (30) given below, the value of the input u is stored in the third component of the state variable, and further stored in the fourth component in the next cycle and then shifted to the first row and the second row.

$$x ( k + 1 ) = Ax ( k ) + Bu ( k ) \\ y ( k ) = Cx ( k ) \\ x ( 0 ) = [ \begin{matrix}{x}_{1} ( 0 ) \\ {x}_{2} ( 0 ) \\ \begin{matrix}0 \\ 0\end{matrix}\end{matrix} ] , \\ A = [ \begin{matrix}{a}_{11} & {a}_{12} & 0 & {b}_{1} \\ {a}_{21} & {a}_{22} & 0 & {b}_{2} \\ 0 & 0 & 0 & 0 \\ 0 & 0 & 1 & 0\end{matrix} ] , \\ B = [ \begin{matrix}0 \\ 0 \\ \begin{matrix}1 \\ 0\end{matrix}\end{matrix} ] , \\ C = [ {c}_{1} {c}_{2} 0 \; 0 ] \qquad ( 30 )$$

In the example of the equation (30), the order of the state variable is 4, which is the sum of 2 as the model order, and 2 as a value taking into consideration the dead time.

By the analogy with the above discussion, it is understood that the relation n=n_{d1}+dₜ₁+n_{d2}+dₜ₂ holds in the present embodiment.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention has been described in detail, it should be understood that the various changes, substitutions, and alterations could be made hereto without departing from the spirit and scope of the invention.

What is claimed is:

1. An air conditioning control system, comprising:
an electronic apparatus having an intake surface from which cooling air is taken in and an exhaust surface from which the cooling air is discharged;
a flow path through which the cooling air discharged from the exhaust surface is returned to the intake surface;
a damper which is provided in the flow path, an opening extent of the damper being adjustable;
a temperature measuring unit that measures a real temperature of the cooling air at the intake surface;
a humidity measuring unit that measures a real humidity of the cooling air at the intake surface;
a target value changing unit that changes a target temperature of the real temperature in accordance with a value of the real temperature, and also changes a target humidity of the real humidity in accordance with a value of the real humidity; and
a controlling unit that predicts a predicted temperature of the real temperature in a future and a predicted humidity of the real humidity in the future, where the controlling unit controlling the opening extent of the damper such that the predicted temperature becomes close to the target temperature and a predicted humidity becomes close to the target humidity, wherein
the target value changing unit sets the target temperature and the target humidity such that the real temperature and the real humidity are raised and lowered in opposite directions.

2. The air conditioning control system according to claim 1, wherein the target value changing unit changes the target temperature and the target humidity such that the target temperature and the target humidity are raised and lowered in opposite directions each other.

3. The air conditioning control system according to claim 1, wherein the target value changing unit
changes the target temperature to a predetermined lower limit temperature when the real temperature is lower than the lower limit temperature,
changes the target temperature to a predetermined upper limit temperature when the real temperature is higher than the upper limit temperature,
changes the target humidity to a predetermined lower limit humidity when the real humidity is lower than the lower limit humidity, and
changes the target humidity to a predetermined upper limit humidity when the real humidity is higher than the upper limit humidity.

4. The air conditioning control system according to claim 1, wherein the target value changing unit changes the target temperature to a temperature closer to a predetermined lower limit temperature than to a predetermined upper limit temperature when the real temperature lies between the lower limit temperature and the upper limit temperature.

5. The air conditioning control system according to claim 1, further comprising a predicting unit that predicts the predicted temperature and the predicted humidity based on the opening extent of the damper.

6. The air conditioning control system according to claim 5, wherein the predicting unit includes:
a prediction model that predicts the predicted temperature and the predicted humidity based on the opening extent of the damper;
a correcting unit that corrects the predicted temperature and the predicted humidity based on the real temperature and the real humidity;
a cost function that calculates a cost by weighting differences, the differences including a difference between the corrected predicted temperature and the target temperature, and the differences including a difference between the corrected predicted humidity and the target humidity; and
an optimizing unit that calculates a manipulation amount in a predetermined period from a present to a future, the manipulation amount satisfying a predetermined constraint condition and also minimizing the cost.

7. An air conditioning control method, the method comprising:
measuring, by a temperature measuring unit, a real temperature of cooling air that is taken into an electronic apparatus from an intake surface of the electronic apparatus;
measuring, by a humidity measuring unit, a real humidity of the cooling air;
changing, by a target value changing unit, a target temperature of the real temperature in accordance with a value of the real temperature, and changing a target humidity of the real humidity in accordance with a value of the real humidity; and
adjusting, by a control unit, an opening extent of a damper provided in a flow path through which the cooling air discharged from an exhaust surface of the electronic apparatus is returned to the intake surface, where the opening extent being adjusted, by predicting a predicted temperature of the real temperature in a future and a predicted humidity of the real humidity in the future, such that the predicted temperature becomes close to the target temperature and the predicted humidity becomes close to the target humidity, wherein
in the changing the target temperature and the target humidity, the target value changing unit sets the target temperature and the target humidity such that the real temperature and the real humidity are raised and lowered in opposite directions.

8. The air conditioning control method according to claim 7, wherein, in the changing the target temperature and the target humidity, the target value changing unit changes the target temperature and the target humidity such that the target temperature and the target humidity are raised and lowered in opposite directions each other.

9. The air conditioning control method according to claim 7, wherein, in the changing the target temperature and the target humidity, the target value changing unit performs:
changing the target temperature to a predetermined lower limit temperature when the real temperature is lower than the lower limit temperature;
changing the target temperature to a predetermined upper limit temperature when the real temperature is higher than the upper limit temperature;
changing the target humidity to a predetermined lower limit humidity when the real humidity is lower than the lower limit humidity; and
changing the target humidity to a predetermined upper limit humidity when the real humidity is higher than the upper limit humidity.

10. The air conditioning control method according to claim 7, wherein, in the changing the target temperature and the target humidity, the target value changing unit changes the target temperature to a temperature closer to a predetermined lower limit temperature than to a predetermined upper limit temperature when the real temperature lies between the lower limit temperature and the upper limit temperature.

11. The air conditioning control method according to claim 7, wherein, in the adjusting the opening extent of the damper, a predicting unit predicts the predicted temperature and the predicted humidity based on the opening extent of the damper.
